(19) United States
(12) Patent Application Publication
(10) Pub. No.: US 2013/0151102 A1
(43) Pub. Date: Jun. 13, 2013

(54) BRAKE SIGNAL CONTROLLING SYSTEM FOR VEHICLE AND METHOD THEREOF

(71) Applicant: Hwan Cheol Kim, Gimpo-si (KR)

(72) Inventor: Hwan Cheol Kim, Gimpo-si (KR)

(73) Assignee: Hyundai Motor Company, Seoul (KR)

(21) Appl. No.: 13/611,608

(22) Filed: Sep. 12, 2012

(30) Foreign Application Priority Data
Dec. 7, 2011 (KR) 10-2011-0130202

(51) Int. Cl. B60Q 11/00; B60Q 1/44

(52) U.S. Cl. 701/70

(57) ABSTRACT

A brake signal controlling system for a vehicle includes a brake pedal, a master cylinder, a stop lamp to show the operation of a brake to another vehicle, and an ESC system for vehicle stability. The brake signal controlling system may also include a control unit controlling the ESC system, a wake-up unit to selectively operate the ESC system, a pressure sensor to receive the information on pressure of the master cylinder, a plurality of sensors to transmit the information of a travel situation to the ESC system, and a lamp turn-on relay connected to the ESC system and selectively turning on the stop lamp. A method of controlling a brake signal is also described.

### CROSS-REFERENCE TO RELATED APPLICATION

The present application claims priority of Korean Patent Application Number 10-2011-0130202 filed Dec. 7, 2011, the entire contents of which application is incorporated herein for all purposes by this reference.

### BACKGROUND OF INVENTION

1. Field of Invention

The present invention relates to a brake signal controlling system for vehicle and a method thereof, and more particularly, to ESC system, a brake signal controlling system for a vehicle using a pressure sensor provided in the ESC system, and a method thereof.

2. Description of Related Art

In general, vehicles are equipped with various lamps such as headlights, signal lamps, stop lamps, and tail lamps. The stop lamps in the lamps are lamps that inform the drivers of adjacent vehicles that the brake of the vehicle started operating, when the brake of the vehicle started operating, and directly relate to safety. Therefore, it is necessary to check whether the stop lamp normally started operating.

When the brake operates, a stop lamp switch is turned on and the stop lamps are turned on. Therefore, it is possible to determine normal operation of the stop lamps when the brake operates, by checking whether the stop lamp switch normally started operating.

Meanwhile, an ESC (Electronic Stability Control) system of a vehicle is a system for stably controlling the general travel position of the vehicle and ensures stable traveling of the vehicle by automatically and independently controlling the wheels of the vehicle together with the existing ABS (Anti-lock Brake System) and TCS (Traction Control System), even though the driver specifically brakes the vehicle. Further, it is possible to estimate the weight of the vehicle from a braking force by the driver operating the brake and the acceleration/deceleration speed of the vehicle, using the information from a master pressure sensor mounted in the ESC system. The reason that the ESC system estimates the weight of the vehicle is for creating a control model for the estimated weight of the vehicle and ensuring stable traveling of the vehicle in accordance with the created control model.

The stop lamps switch of the related art are turned on/off by the brake pedal. That is, when the brake pedal is pressed down, the contact point is connected and the stop lamps are turned on, and when the brake pedal is released, the contact point is disconnected and the stop lamps are turned off. Further, a brake switch is connected with the stop lamp switch. The brake switch inputs whether the brake operates to the ECU, in an ECS (Electronic Control Suspension) system. In addition, as the brake operates, the power of a storage battery is inputted to the ECU and the height of the vehicle is adjusted.

However, in the stop lamp switch that is operated by contact of the contact point, the contact point may be deformed by carbonization or abrasion and may be easily exposed to environmental factors such as temperature, humidity, and vibration. Therefore, malfunction may occur in the stop lamp switch. Further, in a vehicle equipped with a button type of starter, a defect may be generated in starting when the brake switch breakages.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a brake signal controlling system for a vehicle having advantages of preventing a malfunction of a stop lamp switch and allowing normal starting and braking, and a method thereof.

Various aspects of the present invention provide for a brake signal controlling system for a vehicle that includes a brake pedal operated by a driver, a master cylinder converting the operation of the brake pedal into a hydraulic pressure, a stop lamp turned on to show the operation of a brake to another vehicle, and an ESC system controlling the travel position of a vehicle to be stable, the brake signal controlling system including a control unit controlling the ESC system, a wake-up unit disposed in the control unit to selectively operate the ESC system, with the engine of the vehicle stopped, a pressure sensor disposed in the ESC system to receive the information on pressure of the master cylinder, a plurality of sensors disposed to transmit the information of a travel situation of the vehicle to the ESC system, and a lamp turn-on relay connected to the ESC system and selectively turning on the stop lamp.

The system may further include a seatbelt switch transmitting a signal to the wake-up unit, when a seatbelt is fastened and a door switch transmitting a signal to the wake-up unit when a door is opened/closed, in which the wake-up unit may be operated by receiving a signal from the seatbelt switch or the door switch and may stop when the engine of the vehicle is not started within a predetermined time.

The plurality of sensors may include a wheel speed sensor and a Yaw&G sensor.

The ESC system may receive the information of a travel situation of the vehicle and calculates a deceleration speed of the vehicle.

The ESC system may operate the lamp turn-on relay to turn on the stop lamp, when the deceleration speed of the vehicle is a predetermined value or more.

The ESC system may operate the lamp turn-on relay to turn on the stop lamp when the pressure of the master cylinder is a predetermined value or more.

Various aspects of the present invention provide for a method of controlling a brake signal in a vehicle equipped with a brake signal controlling system for a vehicle that includes a master cylinder generating a hydraulic pressure for operating a brake, a stop lamp turned on to show the operation of a brake to another vehicle, an ESC system controlling the travel position of a vehicle to be stable, and a wake-up unit selectively operating the ESC system, the method including operating the ESC system, with the engine of the vehicle stopped, by using the wake-up unit, determining whether the engine of the vehicle is started, calculating pressure of the master cylinder pressure and deceleration speed of the vehicle, determining whether the master cylinder pressure and the deceleration speed of the vehicle are predetermined values or more, respectively, determining that the brake started operating, when at least one of the pressure of the master cylinder pressure and the deceleration speed of the vehicle is the predetermined value or more, and turning on the stop lamp when it is determined that the brake started operating.

The pressure of the master cylinder and the deceleration speed of the vehicle may be calculated, when it is determined that the engine of the vehicle started operating.

The pressure of the master cylinder may be calculated, when it is determined that the engine of the vehicle has stopped.

As described above, according to various aspects of the present invention, as the stop lamp switch is removed, it is possible to prevent the contact point of the stop lamp switch from being deformed by carbonization and abrasion and being exposed to environmental factors such as temperature, humidity, and vibration. That is, it is possible to fundamentally prevent a breakage of the stop lamp switch.

Further, as the wake-up unit that operates the ESC system, with the engine of the vehicle stopped, starting and braking can be normally performed.

In addition, since the stop lamp switch is removed and the electronic relay connected to the stop lamp switch is correspondingly removed, the manufacturing cost can be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary brake signal controlling system for a vehicle according to the present invention.

FIG. 2 is a schematic diagram of an exemplary wake-up unit according to the present invention.

FIG. 3 is a flowchart of an exemplary method of controlling a brake signal for a vehicle according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

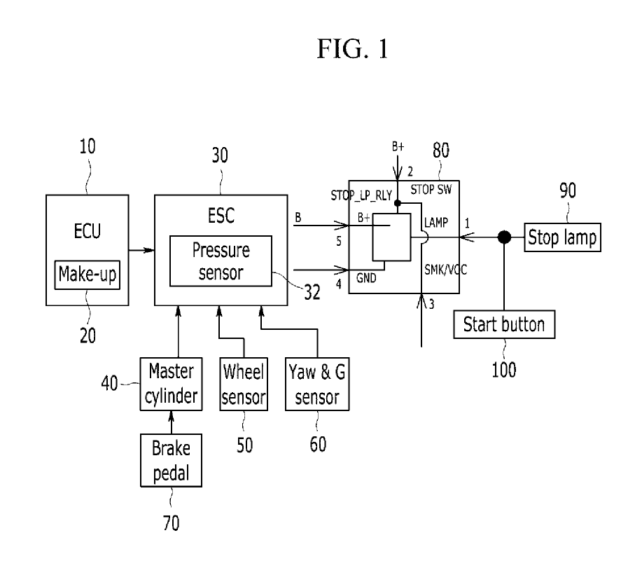

FIG. 1 is a schematic diagram of a brake signal controlling system for a vehicle according to various embodiments of the present invention.

As shown in FIG. 1, a brake signal controlling system for a vehicle according to various embodiments of the present invention includes an ESC system 30, a control unit 10, a wake-up unit 20, a master cylinder 40, a pressure sensor 32, a wheel speed sensor 50, a Yaw&G sensor 60, a lamp turn-on relay 80, a stop lamp 90, and a start button 100.

The ESC system 30 is an electronic stability control system for a vehicle, for controlling the general travel position of a vehicle to be stable. Further, the ESC system 30 ensures stable traveling of the vehicle together with the existing ABS (Anti-lock Brake System) and TCS (Traction Control System).

The control unit 10 controls the ESC system 30. That is, the ESC system 30 is operated by the control unit 10. Further, the control unit 10 may be an ECU (electronic control unit) that operates the circuits and systems in the vehicle.

The wake-up unit 20 is disposed in the control unit 10 to selectively operate the ESC system 30 when the engine of the vehicle has stopped.

The master cylinder 40 converts the operation of a brake pedal 70 operated by a driver into hydraulic pressure. Further, the hydraulic pressure generated from the master cylinder 40 is transmitted to a wheel cylinder and the brake operates.

The pressure sensor 32 is disposed in the ESC system 30. Further, the pressure sensor 32 receives the information on the pressure from the master cylinder 40.

The wheel speed sensor 50 detects the speeds of the wheels of the vehicle. Further, the wheel speed sensor 50 transmits the information on the detected speeds of the wheels to the ESC system 30.

The Yaw&G sensor 60 detects a rotation speed of the vehicle. That is, the Yaw&G sensor 60 detects the speed when a rotational angle of the vehicle changes, and the speed when the vehicle moves to a side. Further, the Yaw&G sensor 60 transmits the information on the detected rotational speed of the vehicle to the ESC system 30.

The lamp turn-on relay 80 is operated by receiving a signal from the ESC system 30. Further, the ESC system 30 selectively operates the lamp turn-on relay 80 in accordance with a pressure value calculated from the information on the pressure of the master cylinder 40 transmitted to the pressure sensor 32 and a deceleration value of the vehicle calculated from the information on the speeds of the wheels and the rotational speed of the vehicle transmitted from the wheel speed sensor 50 and the Yaw&G sensor 60. In addition, the lamp turn-on relay 80 operates when at least one of the pressure value and the deceleration value is a predetermined value or more.

The stop lamp 90 is connected with the lamp turn-on relay 80. Further, the stop lamp 90 is turned on when the lamp turn-on relay 80 operates. That is, the stop lamp 90 informs other vehicles that the brake started operating, when at least one of the pressure value and the deceleration value is the predetermined value or more.

The start button 100 is operated by the driver to start the engine of the vehicle. Further, the start button 100 can operate only when the brake operates. The start button 100 is connected with the lamp turn-on relay 80 and receives a signal that the brake started operating. The signal that the brake started operating may be a signal according to determination that at least one of the pressure value and the deceleration value is the predetermined value or more.

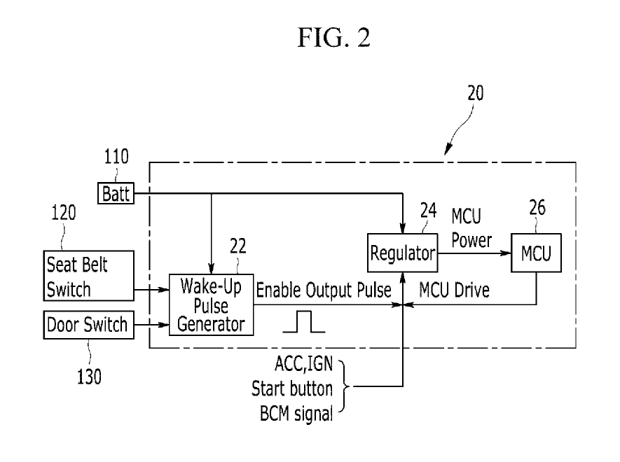

FIG. 2 is a schematic diagram of a wake-up unit according to various embodiments of the present invention.

As shown in FIG. 2, the wake-up unit 20 includes a wake-up generator 22, a regulator 24, and MCU 26. Further, the wake-up unit 20 is connected with a battery 110, seatbelt switch 120, and a door switch 130.

The wake-up generator 22 supplies a voltage for the operation of the wake-up unit 20 in response to a signal transmitted from the seatbelt switch 120 and the door switch 130. Further, the seatbelt switch 120 transmits a signal that a seatbelt has been fastened, to the wake-up generator 22 and door switch 130 transmits a signal that a door is open of closed to the wake-up generator 22. That is, the seatbelt switch 120 and the door switch 130 transmit signals showing that the driver has got in the vehicle to the wake-up generator 22.

The regulator 24 is a device stabilizing the voltage generated from the wake-up generator 22. Further, the wake-up generator 22 and the regulator 24 are supplied with power from the battery 110.

The MCU 2 26 is operated by receiving power from the regulator 24. Further, the MCU 26 controls the wake-up unit 20. That is, the MCU 26 operates the wake-up unit 20. Meanwhile, the wake-up unit 20 stops when it does not receive a signal that the engine of the vehicle started within a predetermined time after receiving a signal that the driver has got in the vehicle from the seatbelt switch 120 and the door switch 130. The signal that the engine of the vehicle started includes an operation signal of an accelerator, an ignition signal of the engine, and a BCM (body control module) signal.

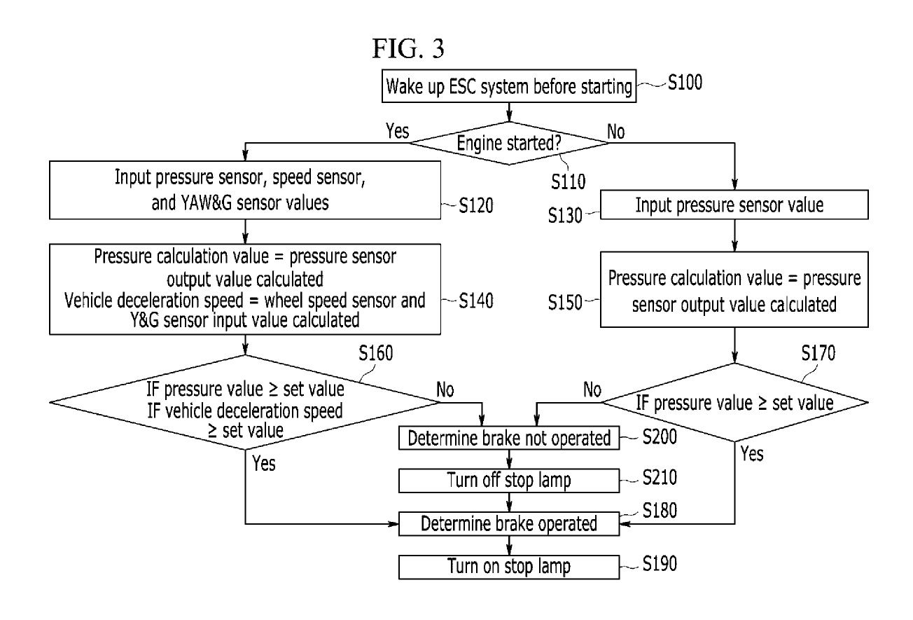

FIG. 3 is a flowchart of a method of controlling a brake signal for a vehicle according to various embodiments of the present invention.

As shown in FIG. 3, when the ESC system 30 is operated (S100) by the wake-up unit 20, with the engine of the vehicle stopped, it is determined whether the engine of the vehicle started (S110).

When it is determined that the engine of the vehicle started, the values detected by the pressure sensor 32, the wheel speed sensor 50, and the Yaw&G sensor 60 are inputted to the ESC system 30 (S120). Further, ESC system 30 calculates the pressure value of the master cylinder 40 from the value inputted from the pressure sensor 32 and calculates a deceleration value of the vehicle from the values inputted from the wheel speed sensor 50 and the Yaw&G sensor 60 (S140).

When the pressure value of the master cylinder 40 and the deceleration value of the vehicle are calculated, it is determined whether the pressure value and the deceleration value are a predetermined value or more, respectively (S160).

When at least one of the pressure value and the deceleration value are a predetermined value or more, it is determined that the brake started operating (S180) and the stop lamp 90 is turned on (S190).

When both the pressure value and the deceleration value less than a predetermined value, it is determined that the brake did not operate (S200) and the stop lamp 90 is turned off (S210).

When it is determined that the engine of the vehicle did not start, the value detected by the pressure sensor 32 is inputted to the ESC system 30 (S130). Further, the ESC system 30 calculates the pressure value of the master cylinder 40 from the value inputted from the pressure sensor 32 (S150).

When the pressure value of the master cylinder 40 is calculated, it is determined whether the pressure value is a predetermined value or more (S170).

When the pressure value is the predetermined value or more, it is determined that the brake started operating (S180) and the stop lamp 90 is turned on (S190).

When the pressure value is less than the predetermined value, it is determined that the brake did not operate (S200) and the stop lamp 90 is turned off (S210).

As described above, according to various embodiments of the present invention, as the stop lamp switch is removed, it is possible to prevent the contact point of the stop lamp switch from being deformed by carbonization and abrasion and being exposed to environmental factors such as temperature, humidity, and vibration. That is, it is possible to fundamentally prevent a breakage of the stop lamp switch.

Further, as the wake-up unit 20 that operates the ESC system 30, with the engine of the vehicle stopped, starting and braking can be normally performed.

In addition, since the stop lamp switch is removed and the electronic relay connected to the stop lamp switch is correspondingly removed, the manufacturing cost can be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A brake signal controlling system for a vehicle that includes a brake pedal operated by a driver, a master cylinder converting the operation of the brake pedal into a hydraulic pressure, a stop lamp turned on to show brake operation to another vehicle, and an Electronic Stability Control (ESC) system controlling the travel position of a vehicle to be stable, the system comprising:
a control unit controlling the ESC system;
a wake-up unit disposed in the control unit to selectively operate the ESC system, with the engine of the vehicle stopped;
a pressure sensor disposed in the ESC system to receive information on pressure of the master cylinder;
a plurality of sensors disposed to transmit the information of a travel situation of the vehicle to the ESC system; and
a lamp turn-on relay connected to the ESC system and selectively turning on the stop lamp.

2. The system of claim 1, further comprising:
a seatbelt switch transmitting a signal to the wake-up unit, when a seatbelt is fastened; and
a door switch transmitting a signal to the wake-up unit when a door is opened/closed,
wherein the wake-up unit is operated by receiving a signal from the seatbelt switch or the door switch and stops when the engine of the vehicle is not started within a predetermined time.

3. The system of claim 1, wherein:
the plurality of sensors include a wheel speed sensor and a Yaw&G sensor.

4. The system of claim 1, wherein:
the ESC system receives the information of a travel situation of the vehicle and calculates a deceleration speed of the vehicle.

5. The system of claim 4, wherein:
the ESC system operates the lamp turn-on relay to turn on the stop lamp, when the deceleration speed of the vehicle is at least a predetermined value.

6. The system of claim 1, wherein:
the ESC system operates the lamp turn-on relay to turn on the stop lamp when the pressure of the master cylinder is at least a predetermined value.

7. A method of controlling a brake signal in a vehicle equipped with a brake signal controlling system for a vehicle that includes a master cylinder generating a hydraulic pressure for operating a brake, a stop lamp turned on to show brake operation to another vehicle, an ESC system controlling the travel position of a vehicle to be stable, and a wake-up unit selectively operating the ESC system, the method comprising:
operating the ESC system, with the engine of the vehicle stopped, by using the wake-up unit;
determining whether the engine of the vehicle is started;
calculating pressure of the master cylinder pressure and deceleration speed of the vehicle;
determining whether the pressure of the master cylinder pressure and the deceleration speed of the vehicle are predetermined values or more, respectively;
determining that the brake started operating, when at least one of the pressure of the master cylinder pressure and the deceleration speed of the vehicle is the predetermined value or more; and
turning on the stop lamp when it is determined that the brake started operating.

8. The method of claim 7, wherein:
the pressure of the master cylinder and the deceleration speed of the vehicle are calculated, when it is determined that the engine of the vehicle started operating.

9. The method of claim 7, wherein:
the pressure of the master cylinder is calculated, when it is determined that the engine of the vehicle has stopped.
